(19) United States
(12) Patent Application Publication
(10) Pub. No.: US 2011/0224063 A1
(43) Pub. Date: Sep. 15, 2011

(54) Rotor For A Centrifuge

(75) Inventor: Thorsten Singer, Hilden (DE)

(73) Assignee: QIAGEN GMBH, Hilden (DE)

(21) Appl. No.: 13/124,348

(22) PCT Filed: Oct. 13, 2009
(86) PCT No.: PCT/EP2009/063322

§ 371 Date: Jun. 2, 2011

(30) Foreign Application Priority Data
Oct. 17, 2008 (DE) 102008052232.5

(51) Int. Cl. B04B 5/04; B01D 21/26

(52) U.S. Cl. 494/37; 494/43

(57) ABSTRACT

An apparatus (10) for a centrifuge for isolating and/or purifying biomolecules has a rotor body (12) for rotatable mounting around a rotation axis in the centrifuge. According to the invention, the rotor body (12) has in addition at least one channel (14) for channeling a sample liquid. The integration of the channel (14) into the rotor body (12) simplifies the isolation and/or purification process, and the longer usable path for separating samples leads to improved separation.

The invention relates to an apparatus for isolating and/or purifying biomolecules, to an appropriate centrifuge, and to a process for centrifuging sample liquids.

Appropriate apparatuses and processes are used in the isolation and/or purification of biomolecules, for example in the purification of nucleic acids, and also, in general, in the separation of liquids.

Processes for isolating or purifying biomolecules are generally known. There exists a very wide variety of single-step and multistep processes. These are carried out either manually by an appropriately trained specialist, according to an exactly predefined procedure, or in an automated manner by means of appropriate systems. In many processes, use is made of a centrifuge for at least one process step.

An example of such a centrifuge is the laboratory centrifuge with rotor described in DE 20 2005 006273 U1. The rotor rotatable around a centrally arranged rotor hub has a rotor lid and slots having openings on the upper side for vessels at a distance from the hub axis. The vessels accommodated in the slots can be filled with a liquid to be separated. Separation is achieved by centrifugation.

The disadvantages in the case of the known manual processes are that they are labor-intensive and also time-consuming and that the high requirements in some cases that the processes be carried out exactly place great demands on the operating personnel. Although these disadvantages are considerably reduced in part in the case of the automated systems, these systems are, however, very complex and expensive.

The object of the invention is to provide an apparatus for isolating and/or purifying biomolecules, an appropriate centrifuge, and a process for centrifuging sample liquids which considerably simplifies how the manual processes are carried out without reaching the complexity and the costs of the automated systems and, at the same time, involves an improvement in isolation and/or purification.

The object is achieved according to the invention by an apparatus having the features of claim 1, by a centrifuge having the features of claim 13, and also by a process having the features of claim 14. Advantageous designs of the invention are specified in the subclaims.

The apparatus according to the invention for isolating and/or purifying biomolecules, which can also be used advantageously for purifying nucleic acids, has a rotor body rotatably mounted in a centrifuge. According to the invention, the rotor body has at least one channel for channeling a sample liquid.

In the context of the invention, a rotor body means both a separate rotor for a centrifuge and also an ancillary body which can be permanently or detachably connected to the rotors in existing centrifuges, for example by insertion.

The integration of the channel for the sample liquid into the rotor body simplifies the manual processes. Once this channel is loaded with a separation, isolation or purification matrix suitable for the process and also with the sample liquid, the additional processing operation proceeds by itself in the centrifuge.

By virtue of the inventive design of the rotor body, the path available for separation is no longer limited by the size of the vessels matching the centrifuge rotor. The longer available path of the channels allows better separation, since the sample liquid, comparable to gas chromatography, covers unimpeded a longer route through the at least one channel. The better separation makes the centrifugation of multiple fractions unnecessary and results in a reduced workload. The channels can be designed to be continuous, without multiple obstacles that might impair the separation, and thus enable an unimpeded, continuous flow through an especially substantially constant cross section. Since the migration path of the sample liquid is extendable compared to conventional processes, the separation quality and selectivity can also be distinctly improved in one-step processes, such as gel filtration for example.

The rotor can be designed to have a multiplicity of channels, enabling multiple samples to be separated simultaneously in one step. The channels can be formed by the rotor body itself. The inlets for loading the channels can also be arranged next to one another in groups, more particularly in groups of eight, to enable processing with multichannel pipets.

The rotor can be intended for one-time use and manufactured from plastic injection molding. For cost-effective manufacturing of more complex channel paths, the rotor can also be designed as two or more shells, with it being possible to form the channels between the shells.

In a preferred embodiment, there is provided a central fill opening connected to the at least one channel, which opening is arranged in the region of the rotation axis of the rotor body. Filling this fill opening with a liquid, for example a separation matrix for the purification of nucleic acids, enables the time-saving filling of the channels with the liquid. After the fill opening has been filled, the separation matrix can be centrifuged into the channels by briefly switching on the centrifuge, and these channels can be filled homogeneously and simultaneously as a result. In the fill opening, there can be designed a rotor hub which runs along the rotation axis of the centrifuge, around which the rotor body is mounted in a rotary manner. The liquid in the fill opening can assume a circular form around the rotor hub. Separation matrices which can be used in particular are gel filtration materials or immobilized metal affinity chromatography (IMAC) materials in order, for example, to retain RNA selectively.

Preferably, the channels of the rotor can have an access opening for introducing the sample liquid. The access opening can be shaped in particular to accommodate a pipet tip. This access opening enables the individual filling of the channels with a liquid, more particularly a sample liquid which, for example, comprises a nucleic acid or proteins. A special design of the access opening for accommodating the pipet tip facilitates filling and ensures that the sample liquid only reaches the respective channel.

Advantageously, the access opening can be arranged radially to the outside of the central fill opening. Thus, the channel can, for example, run radially from the inside to the outside. Thus, all channels can, as explained, be filled simultaneously with, for example, the separation matrix by using the central fill opening, and then each channel can be loaded with its own sample liquid. By means of subsequent centrifugation, the sample liquids are then moved outward through the channel and the matrix located therein and thus separated.

Preferably, the at least one channel has at least one exit opening. This opening is advantageously arranged radially to the outside of the access opening. Parts of the channel contents can be removed externally via the exit opening after passing through the channel.

In addition, the exit opening can advantageously have a fastening device for a small sample flask. The small sample flasks can also be arranged next to one another in groups, more particularly in groups of eight, in order to enable processing with multichannel pipets. If separate collection of the sample liquid from the channels is not necessary and/or if only contamination of a centrifuge casing is to be avoided, it is also possible to fasten a circular collection vessel to the rotor body. The inventive design of the rotor body also enables the closure of one or more channels.

In a particular design of the invention, the at least one channel is designed to accommodate a frit. The frit can already be permanently incorporated into the channel of the rotor, and so separate insertion is not required. In an alternative embodiment, an additional insertion opening is provided for the insertion of the frit. It is also possible for the frit to be able to be inserted into the access opening or the exit opening, and, if the frit is inserted via the access opening, the rotor body is rotated in order to transport the frit to the exit opening of the channel. Only then is the separation matrix added and brought into the appropriate position by brief rotation of the rotor body. The frit prevents the separation matrix from escaping via the exit opening.

Inserting the frit makes it possible to centrifuge the sample liquid straight through the frit. An advantage is the possibility of using an individual frit for each channel. The liquid centrifuged through the frit can, for each channel, be collected separately in a small sample flask for further investigation. The frit—supporting the separation matrix—can, for example, retain the unwanted product, and the desired product is present in the eluate, or vice versa.

In a preferred embodiment of the rotor, the channels have paths which are at least partially designed to be proportionally transverse to the radial direction. This embodiment enables, for example, the formation of spiral and/or meandering channel paths. This results in an extension of the channel path which is available for the separation of liquids. This can spare repeat fractionation of samples and thus result in a reduction in the number of the steps required.

This embodiment also makes it possible to coat and/or line the channels with suitable materials on an individual basis, adapted to the samples.

The channel can be formed in particular by a tube, for example a silicone tube. Formation of the channels by tubes enables a more simple construction of the rotor, since the latter only holds the tubes and no longer has to be designed to be sealed. The rotor body can be designed to have protruding bars for fixing the tube. It is equally possible for the rotor body to have indentations into which the tube can be placed.

In configuration, the apparatus can be designed such that the rotor body is suitable for attachment onto a rotor of a centrifuge known per se. This can spare capital expenditure on costly specialist equipment, for example fully automated systems, more particularly for purifying nucleic acids, and also enable cost-effective purification of nucleic acids for smaller laboratories. Through the use of the laboratory centrifuge which is often already present in many cases, the benefits according to the invention can be utilized without any major capital expenditure.

The invention further relates to a process for centrifuging sample liquids, for example for purifying nucleic acids. Firstly, an apparatus which can be designed and further developed as described above is provided. The channels of the rotor are at least partially wetted with a separation matrix and filled with a sample liquid. Owing to the rotation of the rotor, the sample liquid is at least partially separated.

Thus, the advantages according to the invention, exactly like those for the apparatus described above, are achieved and an improved separation is achieved.

Preferably, during the process, for example before wetting the at least one channel with the separation matrix, it is possible to insert a frit into the channel via the access opening or the exit opening, and, if the frit is inserted via the access opening, the rotor body is rotated in order to transport the frit to the exit opening of the channel. The choice of frit can be adapted to the respective sample. In this case, only then are wetting and separation of the sample liquid carried out.

In configuration, the partial wetting of the at least one channel with the separation matrix is brought about by introducing the separation matrix substance into the central fill opening and subsequently rotating the apparatus.

If necessary, the process can be repeated at least once with the liquid which is at least partially separated.

The invention is explained in more detail below with reference to the attached drawings and on the basis of preferred exemplary embodiments.

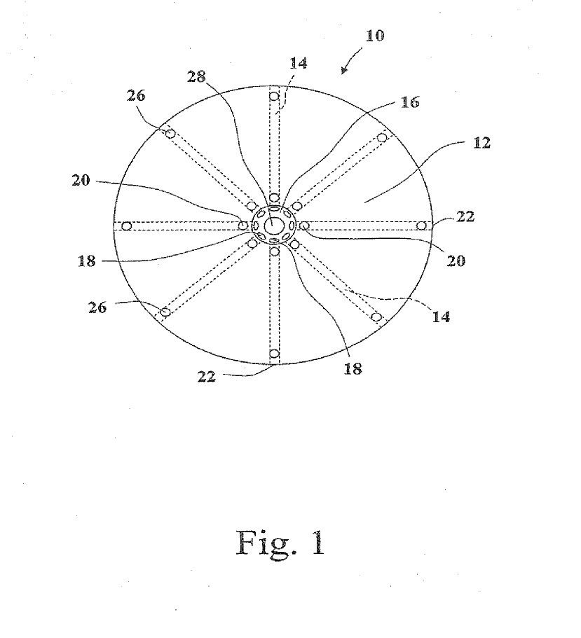

FIG. 1 shows a schematic view of the apparatus according to the invention in the form of a rotor for a centrifuge,

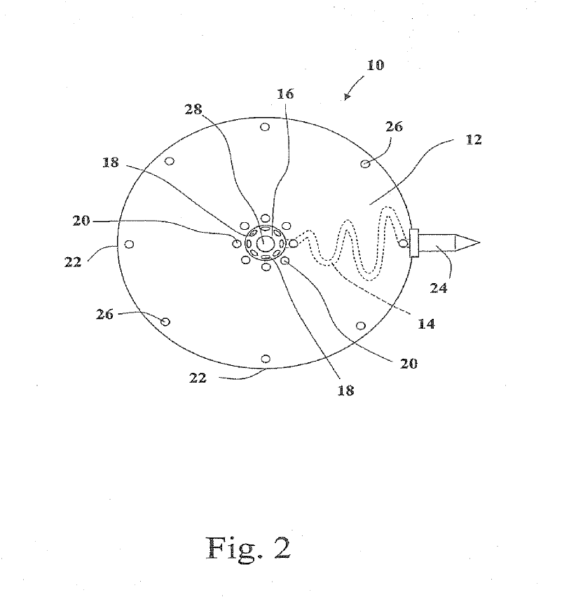

FIG. 2 shows a schematic view of an apparatus according to the invention in a second embodiment.

The apparatus 10 according to the invention depicted in FIG. 1 consists of a rotor for a centrifuge and comprises a rotor body 12 for rotatable mounting in a centrifuge known per se which is not described in further detail. The rotor body 12 has at its center a fill opening 16, in which there is formed a rotor hub 28 which runs along the rotation axis of the centrifuge and around which the rotor body 12 is rotatably mounted. The rotor body 12 has multiple channels 14 for channeling a sample liquid, for example lysate. The fill opening 16 is used to receive a separation matrix which is distributed by brief centrifugation from the fill opening 16 straight through openings 18 into the individual channels 14. The samples are introduced via access openings 20 into the channels 14 wetted with the separation matrix. Frits used for separating the samples are inserted via exit openings 22 arranged on the outside of the channels 14, via an insertion opening 26, or via the access openings 20 in the respective channel 14, and in the last-mentioned case, moved outwards in the channels 14 by brief centrifugation before filling the separation matrix.

The rotor body 12 can, as depicted exemplarily in FIG. 2, have channels 14 which are designed to be meandering in order to extend the path available for separating the samples. At one of the exit openings 22, there is depicted by way of example a small sample flask 24 which can receive the sample liquid during centrifugation. For further processing with multichannel pipets, multiple small sample flasks 24 next to one another in flexible strips can be attached.

1. An apparatus for isolating and/or purifying biomolecules, comprising a rotor body which is rotatably mounted in a centrifuge, wherein the rotor body has at least one channel for channeling a sample liquid.

2. The apparatus as claimed in claim 1, wherein there is provided a central fill opening which is connected to the at least one channel and which is arranged in a region of a rotation axis of the rotor body.

3. The apparatus as claimed in claim 1, wherein the at least one channel has an access opening for introducing the sample liquid.

4. The apparatus as claimed in claim 3, wherein the access opening is arranged radially to an outside portion of the central fill opening.

5. The apparatus as claimed in claim 1, wherein the at least one channel has at least one exit opening.

6. The apparatus as claimed in claim 5, wherein the exit opening is arranged radially to an outside portion of the access opening.

7. The apparatus as claimed in claim 5, wherein the exit opening has a fastening device for a sample flask.

8. The apparatus as claimed in claim 1, wherein the at least one channel is designed to accommodate a frit.

9. The apparatus as claimed in claim 8, wherein the frit can be inserted into the access opening or into the exit opening.

10. The apparatus as claimed in claim 1, wherein the at least one channel has channel paths which are at least partially designed to be proportionally transverse to a radial direction, and so the channel is at least partially designed to be spiral and/or meandering.

11. The apparatus as claimed in claim 1, wherein the channel is designed to be a tube or a silicone tube.

12. The apparatus as claimed in claim 1, wherein the rotor body is designed to be attached onto a rotor of a centrifuge.

13. A centrifuge for isolating and/or purifying biomolecules, comprising an apparatus as claimed in claim 1.

14. A process for centrifuging sample liquids, comprising providing an apparatus as claimed in claim 1,
at least partially wetting said at least one channel with a separation matrix, introducing the sample liquid into the at least one wetted channel, rotating the apparatus for at least partial separation of the sample liquid.

15. The process as claimed in claim 14, wherein, before wetting the at least one channel with the separation matrix, a frit is inserted into the channel via an access opening or an exit opening; and if the frit is inserted via an access opening, the rotor body is rotated in order to transport the frit to an exit opening of the channel.

16. The process as claimed in claim 14, wherein the partial wetting of the at least one channel with the separation matrix is brought about by introducing the separation matrix substance into a central fill opening and subsequently rotating the apparatus.

17. The process as claimed in claim 14, wherein the process is repeated at least once with the sample liquid which is already at least partially separated.
